(19) United States
(12) Patent Application Publication
(10) Pub. No.: US 2017/0039332 A1
(43) Pub. Date: Feb. 9, 2017

(54) SELECTING HEALTH NOTIFICATIONS BASED ON USER ACTIVITY

(71) Applicant: Microsoft Technology Licensing, LLC, Redmond, WA (US)

(72) Inventors: Elad Yom-Tov, Hoshaya (IL); Hadas Bitran, Ramat Hasharon (IL); Nazia Zaman, Kirkland, WA (US); Brian Bilodeau, Redmond, WA (US); Katherine Winant Osborne, Kirkland, WA (US); David A. Wickert, Redmond, WA (US); Ran Gilad-Bachrach, Bellevue, WA (US); Gerrit Hendrik Hofmeester, Woodinville, WA (US); Farah Shariff, Kirkland, WA (US)

(73) Assignee: Microsoft Technology Licensing, LLC, Redmond, WA (US)

(21) Appl. No.: 14/968,645

(22) Filed: Dec. 14, 2015

Related U.S. Application Data
(60) Provisional application No. 62/202,125, filed on Aug. 6, 2015.

(51) Int. Cl. G06F 19/00; G06F 1/16; G06N 99/00

(52) U.S. Cl. CPC G06F 19/34; G06N 99/005; G06F 1/163

(57) ABSTRACT

A method for presenting health notifications begins with creating a plurality of different health notifications, each conveying the same type of information. Each of the different health notifications is provided to a plurality of different users, each user categorized with user health metrics. Post-health notification user activity is tracked for each of the different users. A machine-learning classification machine is trained with tracked user activity, along with corresponding user health metrics, for each of the different health notifications. When provided with user health metrics received from a health-monitoring computing device associated with a user, the machine-learning classification machine chooses a selected health notification for the user from among the different health notifications, the selected notification determined to be more likely than any of the other health notifications to elicit a healthy response from the user. The selected health notification is then sent to the user.

### CROSS REFERENCE TO RELATED APPLICATIONS

This application claims priority to U.S. Provisional Patent Application No. 62/202,125, filed Aug. 6, 2015, the entirety of which is hereby incorporated herein by reference.

### BACKGROUND

Individuals can use health-monitoring devices to record various health metrics, including height, weight, resting heart rate, hours of sleep per night, steps taken per day, etc. This information may be uploaded to a physical-health service for storage and/or analysis. The physical-health service can send health notifications conveying information pertaining to a user's health to various computing devices associated with the user.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A method for presenting health notifications includes creating a plurality of different health notifications, each conveying the same type of information. Each of the different health notifications is provided to a plurality of different users, each user categorized with user health metrics. Post-health notification user activity is tracked for each of the different users. A machine-learning classification machine is trained with tracked user activity, along with corresponding user health metrics, for each of the different health notifications. When provided with user health metrics received from a health-monitoring computing device associated with a user, the machine-learning classification machine chooses a selected health notification for the user from among the different health notifications, the selected notification determined to be more likely than any of the other health notifications to elicit a healthy response from the user. The selected health notification is then sent to the user.

### BRIEF DESCRIPTION OF THE DRAWINGS

FIG. 1 schematically shows an example health platform.

FIG. 2 schematically shows an example of health notification selection and presentation.

FIG. 3 schematically shows a virtual coordinate space with input vectors corresponding to user health metrics.

FIG. 4 schematically shows an example method for presenting a health notification.

FIGS. 5A and 5B show aspects of an example wearable computing device.

FIG. 6 illustrates an example embodiment of a computing system.

### DETAILED DESCRIPTION

The present disclosure is directed to conveying health information to a user through one or more personalized health notifications and/or other interactions. In some examples, computing devices associated with a user may collect health metrics relating to the user, and upload this information to one or more physical-health services associated with a health platform. A physical-health service may be configured to interact with a user by sending to a user information related to one or more aspects of the user's physical health based on the uploaded health metrics. A physical-health service may be able to continually learn how various users respond to different notification strategies. As the physical-health service learns the types of health notifications that are more likely to elicit a healthy response from a given type of user, the physical-health service automatically adopts the learned types of health notifications for that type of user. In this way, the physical-health service is trained to dynamically choose a health notification from a plurality of different health notifications conveying the same type of information, in order to increase the likelihood of eliciting a healthy user response. In particular, the physical-health service may select the notification strategy believed to be most likely to have a positive effect on user behavior. Machine learning may be used to dynamically and progressively tailor the notification strategy according to one or more factors, including, for example, the user's demographic, environmental, and/or health information, as well as how other users have historically responded to health notifications. These notifications may take the form of one or more messages or other computer-initiated interactions, which may be delivered to a user via one or more computing devices associated with the particular user. Further, in some embodiments, it may be determined that no potential health notifications are likely to elicit a healthy response, and as a result, no health notification will be delivered.

Users of a physical-health service may be categorized with a plurality of health metrics, which may be obtained from a variety of sources. A health metric may comprise any information pertaining to a user's demographics, health, activities, lifestyle, preferences, etc. Nonlimiting examples of health metrics may include user age, height, weight, resting heart rate, blood pressure, amount exercised per day/week/month, gender, ethnic background, types of exercise performed, musical preferences, computing device usage habits, etc.

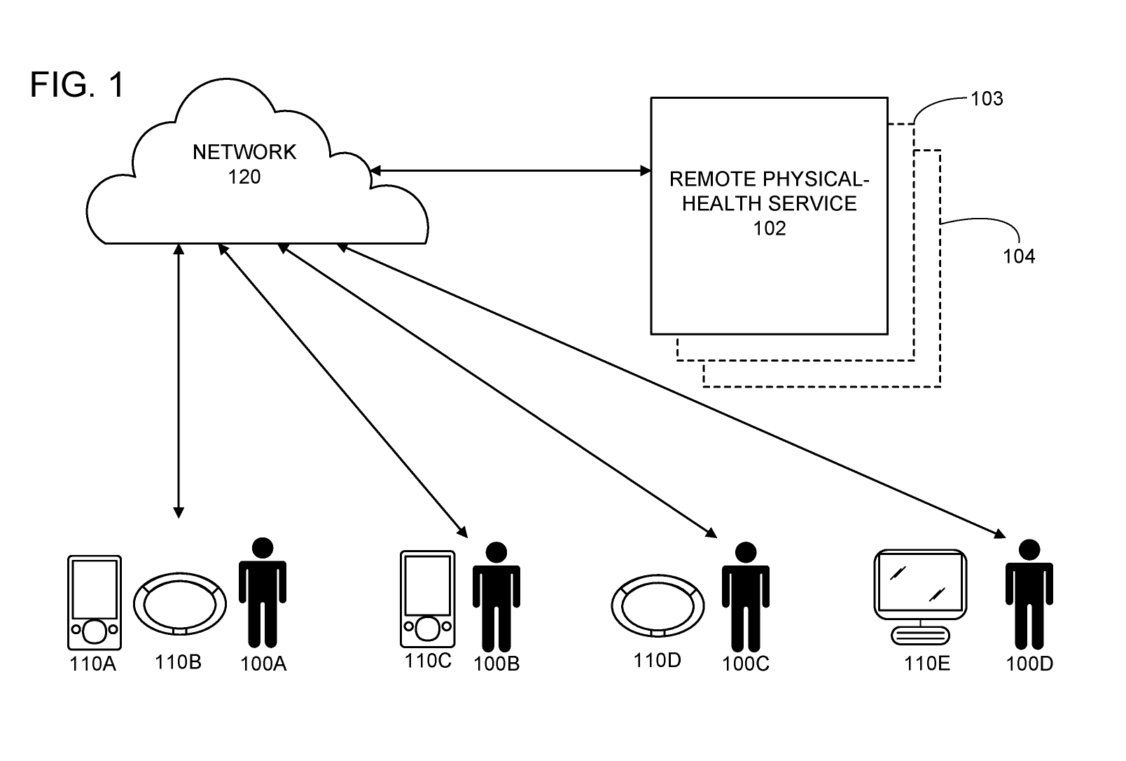

FIG. 1 schematically shows a plurality of different users 100 (e.g., User 100A, User 100B, User 100C and User 100D). Each user is using one or more computing devices 110 (e.g., smartphone 110A, fitness watch 110B, smartphone 110C, fitness watch 110D, and personal computer 110E). A variety of different types of computing devices may be used without departing from the scope of the present disclosure; smartphones, fitness watches, and personal computers are provided as nonlimiting examples. In general, each computing device 110 may be configured to monitor health metrics for a user, receive information pertaining to a user, communicate with one or more physical-health services, present health information to a user, and/or perform other computing functions.

A computing device 110 optionally may include one or more sensors configured to collect information relating to one or more health metrics. As nonlimiting examples, a computing device 110 may include one or more of a microphone, visible-light sensor, ultraviolet sensor, ambient temperature sensor, barometer, contact sensor module, optical sensor module, accelerometer, gyroscope, magnetometer, global positioning system (GPS) receiver, as well as any other applicable sensors. Computing devices 110 including such sensors may be referred to as health-monitoring computing devices.

The microphone may be configured to measure the ambient sound level or receive voice commands from the wearer. For example, a user may issue a voice command indicating that the computing device 110 should begin tracking health metrics. Input from the visible-light sensor, ultraviolet sensor, and ambient temperature sensor may be used to assess aspects of the wearer's environment—e.g., the temperature, overall lighting level, and whether the wearer is indoors or outdoors. Additionally or alternatively, the visible-light sensor, ultraviolet sensor, and ambient temperature sensor may be used individually or in conjunction with other sensors to determine when a user begins a new physical activity, and track aspects of the user's performance.

The accelerometer and gyroscope may furnish inertial and/or rotation rate data along three orthogonal axes as well as rotational data about the three axes, for a combined six degrees of freedom. This sensory data can be used to provide a pedometer/calorie-counting function, for example. Data from the accelerometer and gyroscope may be combined with geomagnetic data from the magnetometer to further define the inertial and rotational data in terms of geographic orientation. The wearable electronic device may include a global positioning system (GPS) receiver for determining the wearer's geographic location, altitude and/or velocity (ground speed, rate of ascent/descent, etc.).

In the case where computing device 110 is a wearable computing device (e.g., fitness watches 110B and 110D), contact and optical sensor modules may be included. Such modules may be configured to directly contact a user's skin, and may measure a number of parameters, including skin electrical resistance and/or capacitance, skin temperature, and whether or not the computing device 110 is currently being worn. Furthermore, the optical sensor module may be used to determine blood flow through the capillaries in the skin and thereby provide a measurement of the wearer's heart rate, blood oxygen level, blood glucose level, and/or other biomarkers with optical properties.

Sensors such as those listed above may track health metrics for a user of a wearable device 110. For example, a computing device may determine the number of steps taken by a user during a period of time (e.g., a day, a week, a single workout session), the user's heart rate at rest and/or during exercise, the number of calories burned by a user during a period of time, a user's body temperature at rest and/or during exercise, the length of time per night a user spends sleeping, the number of times per night a user wakes up, the user's current geographic location, weather conditions at the geographic location, and any other information available. In some examples, computing device 110 may be configured to interpret one or more sudden changes in speed or orientation as the beginning of a workout, and begin tracking health metrics accordingly. A GPS receiver, and/or other location sensor, may be used in order to determine the distance traveled by a user during a period of time (e.g., a workout comprising: walking, running, cycling, and/or swimming). It will be appreciated that the examples provided above are not intended to limit the scope of the disclosure in any way. Computing device 110 may include any number of appropriate sensors, including sensors not explicitly described herein. Additionally, it will be appreciated that the sensors listed above, used either individually or cooperatively, may be used to track any number of health metrics while a user performs any number of activities.

In some examples, a computing device 110 may be able to receive demographic information, environmental information, and/or other health metrics from sources other than dedicated hardware sensors. For example, the computing device may include a user interface allowing a user to manually input health and/or demographic information. The computing device may additionally include a network-communications interface, allowing communications with other computing devices over one or more wired, wireless local and/or wide area networks. As such, a computing device 110 which lacks suitable sensors for health metric collection may still obtain health metrics for a user. For example, a user may perform exercise while wearing a wearable computing device (e.g., fitness watch 110B). Data collected by the wearable computing device may be copied or transferred to one or more other computing devices such as, for example, smartphone 110A or personal computing device 110E. This may allow a user to review health metrics from any one of several computing devices, even if the computing device was not present at the time the data was collected. Additionally or alternatively, a user may manually track health metrics for a workout or other period of activity, and manually enter such information into a computing device 110 via, for example, a user interface, a mouse and keyboard, or other suitable input modality. This may allow a user who does not have access to a computing device with appropriate hardware sensors to nonetheless benefit from health metric storage and analysis.

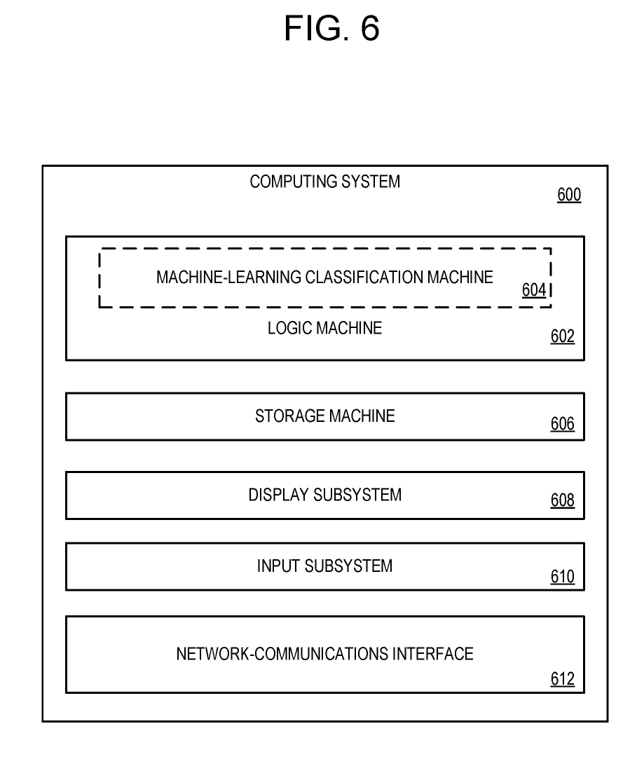

A computing device 110 may be further configured to communicate with one or more physical-health services such as, for example, remote physical-health services 102, 103, and 104. A physical-health service may be implemented as a network-accessible computer in accordance with FIG. 6. In different implementations, the physical-health service may take the form of one or more stand-alone computers communicatively accessible via computing devices 110. A computing device 110 may be configured to communicate with a physical-health service 102 over one or more wired, wireless local and/or wide area networks. A physical-health service may be locally located on the same user computing device that tracks and stores health information for the particular user. In other examples, a physical-health service may be locally located on a companion user computing device. For example, a physical-health service may be located on a smartphone 110A that wirelessly communicates with a fitness watch 110B. In still other examples, a remote physical-health service may be located on one or more remote network-accessible computers, accessible via a computing network such as, for example, network 120.

During communication with a physical-health service, a computing device 110 may upload health metrics gathered and/or stored by the computing device 110 to the physical-health service for storage and/or processing. In this manner, a user may perform a physical activity while one or more computing devices (such as, for example, smartphone 110A or fitness watch 110B) collect health metrics pertaining to the physical activity. This information may then be uploaded to and stored by the physical-health service. The information may be accessed by the uploading computing device and/or one or more other authorized computing devices. For example, a user may regularly engage in physical activities while wearing a fitness watch 110B, and still be able to access historical and/or statistical information regarding the user's physical activities from a personal computer 110E, after the personal computer retrieves the relevant information from the fitness watch and/or from the physical-health service.

A physical-health service may be configured to collect health metrics from a plurality of users 100, and store such information for later access. A physical-health service may additionally be configured to categorize each user according to their uploaded user health metrics, and perform one or more processing and/or analysis functions on the stored health metrics, for the purpose of selecting one or more personalized health notifications intended to convey to a particular user one or more types of health information.

A computing device 110 may in some examples be configured to present a user with information related to the user's physical health. Such information may be collected using one or more hardware sensors, manually input by a user, and/or received from a physical-health service. For example, a computing device 110 may be operable to present one or more health notifications conveying to a user one or more types of information pertaining to the user's physical health, based on health metrics collected by one or more computing devices 110. A health notification may take the form of one or more visual and/or audible notifications and/or other messages or computer-initiated interactions presented to a user. For example, a health notification may include one or more summaries of previous workouts performed, including the duration of the activity, the number of steps taken by the user, the user's maximum heart rate, the number of calories burned, and so on. A computing device 110 may additionally be operable to provide a user with graphs, charts or other summaries, for example indicating changes in a user's weight or body mass index (BMI) over time.

While providing a user with one or more health notifications conveying one or more types of information pertaining to the user's physical health may be useful, in some cases such notifications may inadvertently discourage the user from further activity, or otherwise elicit a negative response. For example, a health notification informing a user that his BMI is relatively higher than similar users may inspire the user to exercise more, or it may demoralize the user, resulting in less exercise. As such, it may in some cases be desirable for physical-health services and/or computing devices to carefully select each health notification presented to a user, in order to increase the probability of the notification eliciting a healthy user response. In some cases, it may be preferable to present no health notification at all.

Whether a health notification has a positive effect, a negative effect, or no effect at all on a user's behavior may depend upon multiple properties of the particular notification selected. For example, the specific words used in a notification, the length of the notification, the type of information conveyed by the notification, the sentiment of the message (e.g., whether the tone of the message is positive, negative, or neutral), and/or the time and place at which the notification was presented, may potentially affect any response the notification elicits from the user. As such, a physical-health service may first recognize a type of information to be conveyed to a user, then choose a selected health notification from among a set of different health notifications, each conveying the recognized information type. Each different health notification of the set may include the same information presented in a different way, according to the properties listed above. For example, a notification could take the form of a text-based message indicating to a user the average number of steps the user has walked each day during the past week. This may be written in several different though potentially valid ways. For example, the notification could read “You've walked, on average, X steps per day this week.” Alternatively, the notification could read “You've averaged X steps per day this week. Good for you!” Each of the above examples may have a different effect on the user's future behavior, and the physical-health service may choose the health notification most likely to elicit a positive response. Each different health notification may be manually created by a human health notification author, and/or automatically created by a physical-health service. It will be appreciated that the health notifications provided above are examples, and are not intended to limit the scope of the present disclosure. A health notification may include information pertaining to virtually any aspect of a user's physical health. Furthermore, any health notification may have any number of alternate versions conveying the same information type and available for selection by a physical-health service.

The physical-health service may choose a selected health notification from among a plurality of different health notifications based upon the user's health metrics, including demographic, environmental, and/or other relevant information. For example, during health notification selection, a physical-health service may consider any number of health metrics used to categorize users of the physical-health service and pertaining to notification selection, including: an activity metric, indicating how much activity a user has performed recently (e.g., in the last 48 hours, the last 24 hours, the current exercise session), activities a user enjoys (e.g., swimming, jogging, hiking, cycling), personal preferences of the user (e.g., musical preferences, computing device usage habits, video games played), etc.; demographic metrics, including a user's age, gender, and other demographic characteristics; physiological metrics, including a user's height, weight, heart rate, and other physiological characteristics; and location metrics, indicating whether a user is near work, at home, on vacation, local weather conditions, and any other relevant location information.

Health metrics may be obtained from any suitable source. As described above, sensors of one or more computing devices may collect health metrics for a user. Further, health metrics may be manually input by a user, and/or collected by one or more applications running on a computing device. For example, a user's exercise history may be obtained from a fitness application. Additional information may be obtained from a calendar application (e.g., whether the user is on vacation or has any upcoming appointments which may render one or more potential health notifications less effective), an Internet browser (e.g., if the user is researching new workout plans or jogging routes), a nutrition app (e.g., if the user is following a particular diet), and/or any other applications and sources of potentially relevant information. In some embodiments, such information may only be collected after receiving explicit consent from the user.

Initially, a physical health service may randomly select health notifications from a plurality of available health notifications, and distribute the randomly selected notifications to users. This may include a machine-learning classification machine of a network-accessible computer performing one or more random selection operations when initially selecting health notifications for distribution to computing devices. In some examples, the distributed health notifications may each convey a same type of information. After a given health notification is presented to a user, the physical-health service may track post-notification user activity, and this information may be used to subsequently train the machine learning classifier in order to more effectively select notifications for the user and/or other users. For example, the physical-health service may determine that, when conveying a particular type of information, certain users respond best to certain types of notifications. Further, the physical-health service may use tracked user activity for notifications conveying a certain information type to select notifications conveying different types of information. For example, users with a particular set of health metrics may prefer health notifications which are shorter and have no emotional sentiment, regardless of the type of information the health notifications are conveying. Other users may prefer to receive health notifications which may be perceived as negative or conveying “bad news” only when the user is at home and has recently engaged in sedentary activities.

During subsequent notification selection, the machine learning classifier may first recognize a type of information to be conveyed to a user via a health notification. The physical-health service may then choose a selected health notification from a set of health notifications conveying the recognized type of information, the selected health notification determined by the physical-health service to be likely to have a positive effect on user behavior, based upon user health metrics and user activity tracked after presentation of prior notifications, regardless of the type of information conveyed by the prior notifications. In some embodiments, the machine-learning classifier may be used to assess the relative likelihood that one type of notification will elicit a more favorable response than another type of notification, and select for presentation the health notification that is most likely to elicit a favorable response.

In other embodiments, Boltzmann sampling or similar mathematical operations may be applied to the outputs of the machine learning classifier. This may result in the selection of a health notification that is determined to be less likely than other health notifications to elicit a healthy user response. For example, a second or third best health notification may be chosen in lieu of the health notification determined to be most likely to elicit a favorable response. Tracking user activity after presentation of health notifications selected in this manner may fulfill an exploration function, wherein machine learning classifiers select health notifications which would not ordinarily be selected. Such exploration helps the machine-learning classifier to effectively test the effectiveness of different candidate health notifications.

Further, a machine learning classifier may be trained to prioritize health notifications likely to elicit long term health benefits over health notifications likely to elicit short term benefits. For example, the machine learning classifier may select health notifications which are only slightly likely to elicit an immediately-recognizable healthy response, or even select health notifications which may elicit a negative short-term response, if it is determined that such notification selection may have a more positive long term effect. In other words, the machine learning classifier may be configured to select notifications which are likely to elicit a healthy user response in the long term, even if such notifications are less likely to elicit a healthy user response in the short term.

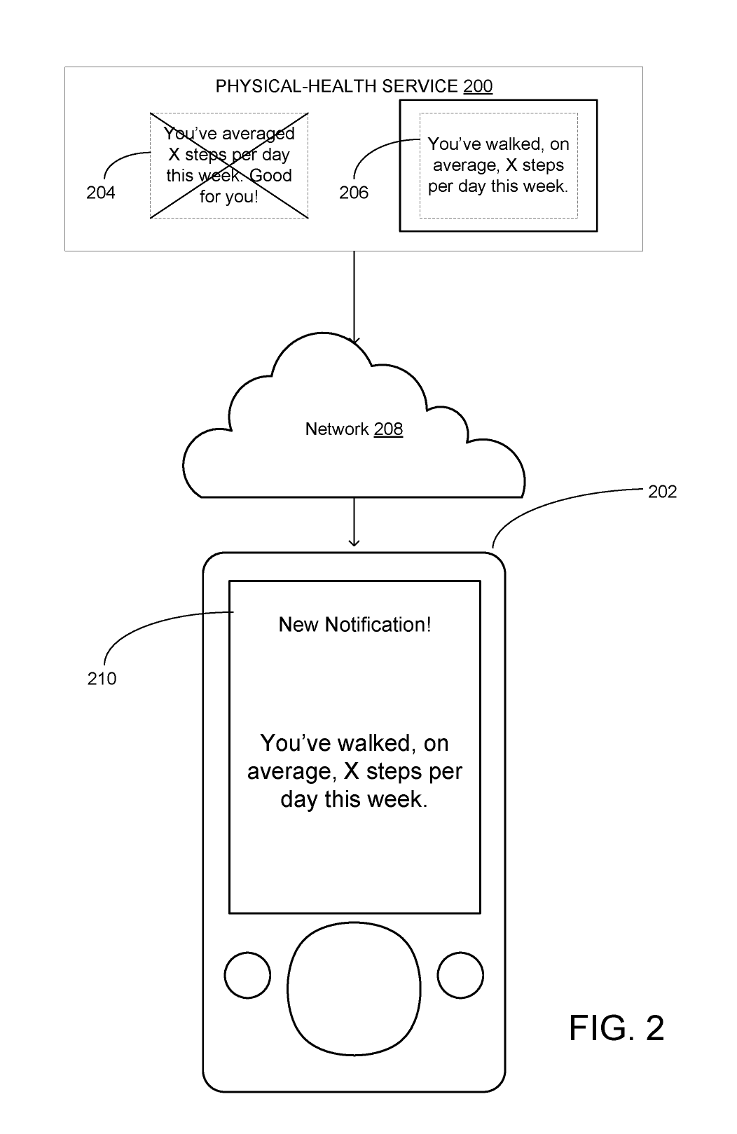

FIG. 2 schematically shows an example physical-health service 200 interacting with a computing device 202. In the illustrated example, physical-health service 200 is programmed to consider two candidate health notifications. In this case, the candidate notifications are text-based health notifications 204 and 206. As shown, physical-health service 200 has chosen text-based health notification 206 as the selected health notification to be presented to a user via computing device 202. As described above, health notification 206 may be selected over health notification 204 because a machine learning classifier determines that health notification 206 will be more likely than health notification 204 to elicit a healthy user response. For example, using information gathered by tracking post-notification user activity for users of the physical-health service, the machine learning classifier may determine that most users typically prefer messages similar to health notification 206.

The current environmental context of the user may also be taken into account during notification selection. For example, a machine learning classifier may determine that many users respond positively to relatively longer messages while at home, and relatively shorter messages while at work. As such, if a physical-health service determines that a user is currently at work, via a GPS receiver for example, the physical-health service may select a relatively shorter message such as, for example, notification 204. Accordingly, a network-accessible computer implementing a physical-health service and/or a machine-learning classification machine associated with the network-accessible computer, may determine a time at which a selected health notification is to be sent to a user.

Additionally or alternatively, the notification selected may vary depending upon the type of computing device the user is currently using. For example, when using a smartphone device, users may prefer relatively shorter messages, and while using a smartphone device to listen to music, users may prefer audible messages rather than text-based notifications.

Further, current weather conditions of a user may be considered. For example, the physical-health service may determine that no notifications typically elicit a healthy response from users who have recently experienced snowfall. In some embodiments, additional factors, such as whether the user is in transit, on vacation, has recently researched illness symptoms, etc. may be considered.

Returning to FIG. 2, after notification 206 is chosen, it is sent to computing device 202 via computer network 208. In other examples, any suitable communication mechanism may be used to link one or more network-accessible computers, responsible for providing one or more physical-health services, with one or more computing devices. In some embodiments, the physical-health service may be stored locally on the computing device. During interaction, selected health notification 206 may be presented to a user via a display 210 of computing device 202, as shown. In some examples, the specific time at which the selected notification is presented may depend upon one or more conditions. For example, the physical-health service 200 or the computing device 202 may wait to present notification 202 until a particular time of day, such as the time at which a user typically wakes up or goes to the gym. Further, the health notification may be sent to any and/or all computing devices associated with the user, only specific computing devices, or only a computing device the user is currently using. Additionally or alternatively, a health notification may direct the user to a web-based health portal accessible from any Internet connected computing device. The type and content of information presented to the user via the web-based health portal may similarly depend upon a variety of factors, as described above.

It will be appreciated that the notifications described above are examples, and are not intended to limit the scope of the present disclosure. Physical-health service 200 may include any number of different health notifications, feedback messages, and/or other computer-initiated interactions usable to convey health information to a user. Examples of such notifications may include, for example, text messages, email messages, application specific notifications (e.g., a health notification is presented to the user once the user opens a particular application and/or interacts with one or more features of the application), system notifications (e.g., notifications which appear in a designated notifications tray in a smartphone device), audible notifications, in-game messages delivered by non-player characters, and/or any other mechanism for delivering information to a user. Further, health notifications may be presented to a user via any number of different computing devices, including smartphones, fitness watches, personal computers, video game consoles, or others not explicitly described herein. Further still, any number of factors may be considered during notification selection and/or presentation, as described above. Health notifications may be created by any suitable entity, including human health-notification authors and/or physical-health services configured to automatically generate health notifications.

As described above, a network-accessible computer, implementing a physical-health service, may provide health notifications to a plurality of computing devices. The physical-health service may track post-notification user activity for each user that received health notifications. For example, the physical-health service may track which activities a user participates in after the health notification presentation, as reported by one or more computing devices or manually reported by a user. Further, the physical-health service may examine newly uploaded health metrics for each user, and identify any changes in user health or activity that have occurred since the health notification presentation. Such information may indicate to a physical-health service whether a recently provided health notification elicited a healthy response, an unhealthy response, or no discernable response from a user the health notification was provided to.

After receiving the tracked post-health notification user activity, the physical-health service may perform one or more processing/analysis steps based on the tracked user activity and corresponding user health metrics in order to choose one or more selected health notifications for a user of the physical-health service. This may be done via a machine-learning classification machine which employs one or more machine-learning classifiers. As such, a machine-learning classification machine may be trained, based on tracked user activity and user health metrics, to choose a selected health notification for any given user. Further, a machine-learning classification machine may be implemented as one or more logic machines and/or other processing components of a network-accessible computer, as will be described below with respect to FIG. 6.

A variety of suitable methods may be used to train the machine-learning classification machine. For instance, if tracked user activity and/or newly received user health metrics indicate positive changes in a user's status and/or behavior (e.g., weight loss, increased exercise, fewer sedentary activities), then the machine-learning classification machine may determine that a delivered health notification elicited a healthy user response. One or more machine learning classifiers may be trained accordingly. Conversely, if negative changes are observed in a user's activity and/or behavior, then a delivered health notification may be identified as having caused a negative user response.

A machine-learning classification machine may implement any suitable types of machine-learning classifiers when choosing selected health notifications. For instance, a machine-learning classification machine may implement one or more decision trees, boosted decision trees, and/or linear classifiers. Further, a machine-learning classification machine may be configured to utilize a variety of different machine-learning classifiers initially, and gradually reconfigured to only utilize machine-learning classifiers which are observed to choose selected health notifications which consistently elicit healthy user responses.

A machine-learning classification machine may implement one or more machine-learning classifiers that accept vectors as inputs, perform one or more operations based upon an input vector, and use an output to choose a selected health notification. Once tracked user activity has been received, a machine learning classifier may be re-trained, such that it generates a different output for a given input vector, or chooses a different selected health notification for a given output. Accordingly, uploaded user health metrics may be converted into vectors before being provided to the machine-learning classification machine. Each vector may include a plurality of dimensions in a virtual coordinate space, where each dimension corresponds to a different user health metric. A virtual coordinate space may include any number of dimensions (e.g., dozens, hundreds, thousands), where each virtual dimension corresponds to a user health metric. Further, each vector may have a component in each dimension, where a magnitude of the vector component in a given dimension is proportional to a value of a user health metric corresponding to the dimension. In this manner, each user of a physical-health service may be represented by a unique vector in a virtual coordinate space, where the orientation of each vector corresponds to values of each unique user's uploaded health metrics.

In some examples, a virtual coordinate space may be constructed using dimensions corresponding to health metrics that do not share a common scale. For example, one dimension may correspond to weight (measured in pounds, kilograms, etc.) while another corresponds to height (measured in inches, centimeters, etc.). Normal human weight may range from under one hundred pounds to several hundreds of pounds, while normal human height may range from under fifty inches to over eighty inches. As a result, if users were represented in a virtual space by vectors, each vector having vector components with magnitudes equal to the exact height and weight of the users, then the vectors would exhibit a wide variety of different weight magnitudes, and a relatively limited variety of different height magnitudes. This may result in the difference in orientation between two vectors being more clearly defined by the difference in weight between the users, rather than the difference in height.

Accordingly, when constructing a virtual coordinate space, each dimension of the virtual space may be normalized to a shared scale. In particular, a range of each dimension may be adjusted, such that each dimension shares a common minimum value and a common maximum value. These values may be, for example, zero and one. In such an example, one or more processing operations may be performed such that all values of each health metric are converted to values between zero and one. As such, a user with an approximately average height may be represented by a vector having a component in the height dimension with a magnitude of approximately 0.5, while a user with an approximately average weight is represented by a vector having a component in the weight dimension with a magnitude of approximately 0.5. Users with health metric values higher or lower than most other users may be represented by vectors having component magnitudes close to one or zero, respectively.

Alternatively, a scale of each dimension in the virtual space may be adjusted, and a scale of one or more dimensions may be adjusted to a weighted scale, which is different from scales of other dimensions. For example, it may be determined that user age is a better indicator of overall user health and behavior than user height, weight, and/or other health metrics. Accordingly, in order to select more effective health notifications, a difference in age between two users should have a greater impact on the health notifications chosen for the two users than a difference in height. Therefore, a dimension associated with user age may be adjusted to a weighted scale, where two users with a certain age difference are represented by more dissimilar vectors than two users with a proportionally similar difference in height.

Further, one or more dimensions in the virtual coordinate space may be adjusted to have a scale that is not linear. For example, it may be desirable to associate one or more health metrics with dimensions that utilize logarithmic scales rather than linear scales. Additionally or alternatively, a scale of a dimension may be adjusted such that a given difference in a health metric has a greater impact on vector orientation for values that are close to average than for values which are far from average. For example, a given difference in weight for two users of approximately average weight may correspond to a greater difference in vector orientation than the same difference in weight for two users of far greater than average weight. Such a strategy may allow a physical-health service to maximize a resolution of a virtual coordinate space for most values, while minimizing the potential for outlier values to negatively impact the difference between vectors representing typical users. In general, any linear or non-linear scale may be used for any one or more dimensions.

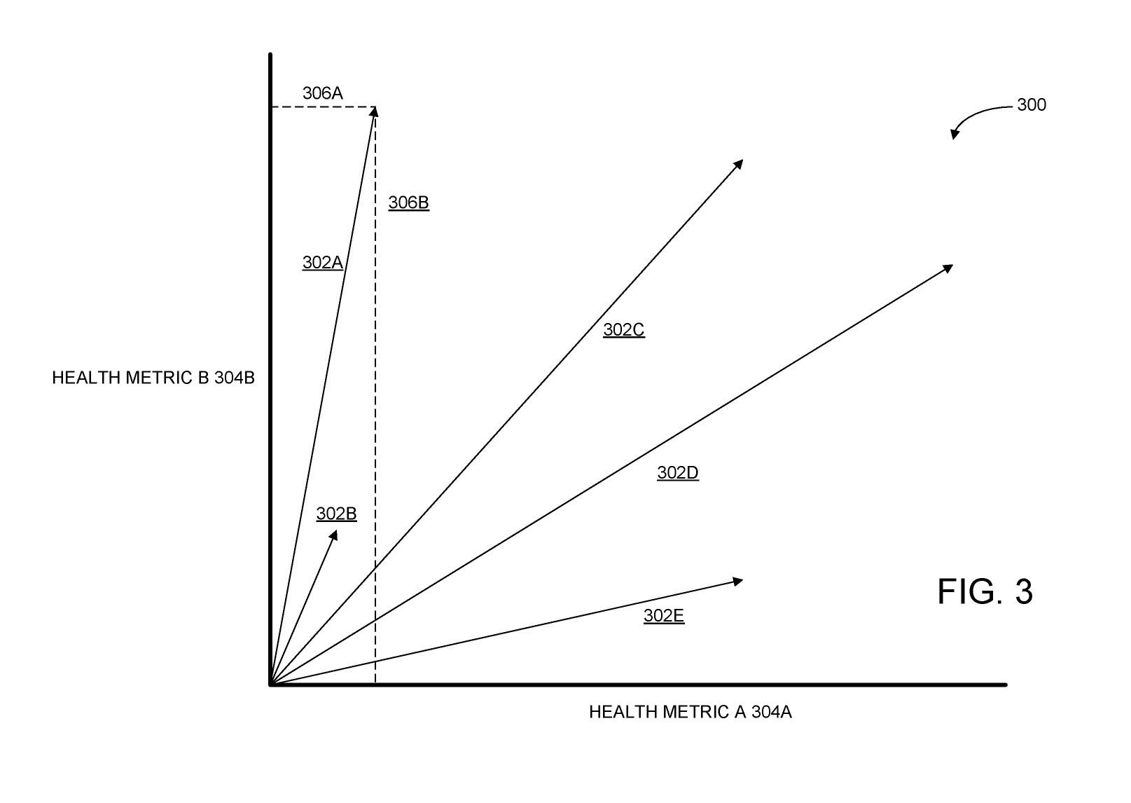

FIG. 3 shows an example virtual coordinate space 300, as described above. Virtual coordinate space 300 includes a number of vectors 302, where each vector is associated with a different user. Coordinate space 300 includes two different dimensions 304, where each dimension 304 is associated with a different user health metric. Specifically, dimension 304A is associated with health metric A, and dimension 304B is associated with health metric B. Health metrics A and B may be any suitable user health metrics including, for example, height, weight, resting heart rate, hours of sleep per night, gender, local temperature, local chance of precipitation, etc.

Each vector 302 in virtual coordinate space 300 corresponds to values of user health metrics of each associated user. For example, vector 302A corresponds to a user with a relatively low value in health metric A, and a relatively high value in health metric B. This may be seen by examining the vector components 306 of vector 302A. Vector component 306A, corresponding to health metric A, has a relatively small magnitude, proportional to a relatively small value of health metric A, while vector component 306B, corresponding to health metric B, has a relatively large magnitude, proportional to a relatively large value of health metric B. In contrast, vector 302B corresponds to a user with relatively low values for both health metrics A and B. Though vector components are not shown for vector 302B, or other vectors 302C, 302D, and 302E in FIG. 3, these vectors do have components in each dimension 304. In an example where health metric A corresponds to user height, and health metric B corresponds to user weight, then vector 302A may identify a user who is short and heavy, while vector 302B identifies a similarly short though much lighter user.

Though only positive coordinate space is shown in FIG. 3, in some embodiments vectors may have negative components in one or more dimensions. For instance, if a dimension corresponds to a health metric which indicates a user's change in weight over time, then a user who has lost weight may have a negative vector component in a dimension corresponding to the health metric.

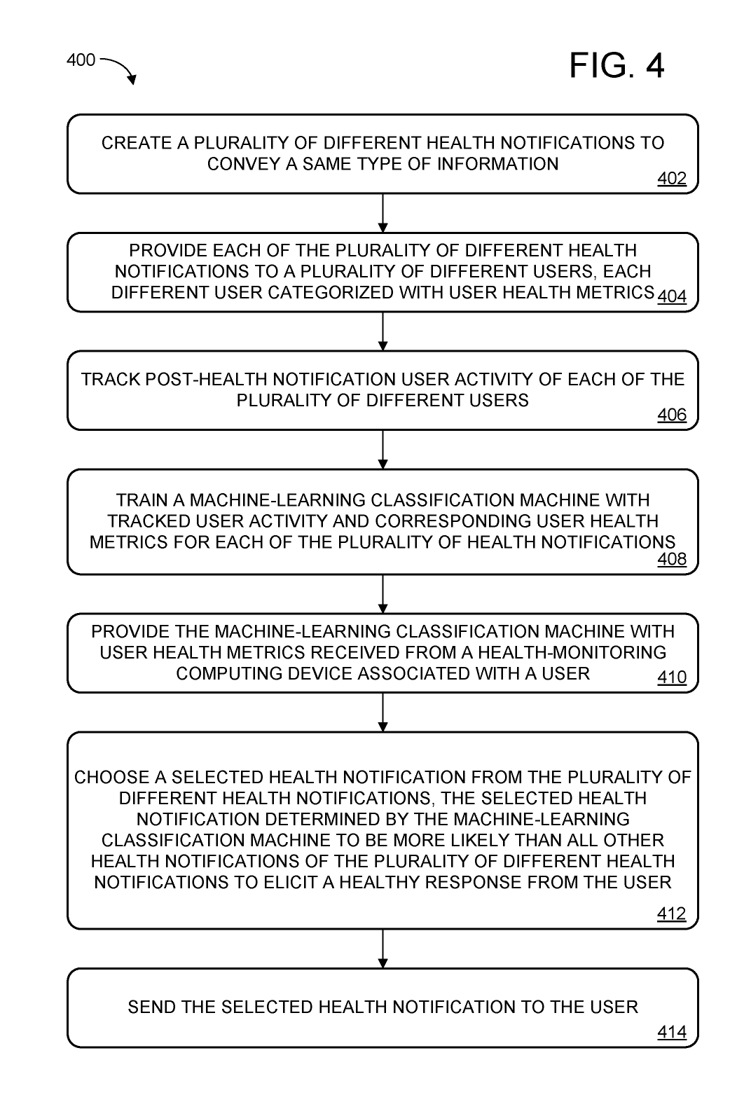

FIG. 4 shows an example method 400 for presenting health notifications. At 402, method 400 includes creating a plurality of different health notifications to convey a same type of information. The plurality of different health notifications may be created by one or more human health notification authors and/or automatically generated by a physical-health service.

At 404, method 400 includes providing each of the plurality of different health notifications to a plurality of different users, each different user categorized with user health metrics. A physical-health service, implemented on a network-accessible computer, may randomly select different health notifications of the plurality to provide to each user, thereby generating more diverse data usable for training the machine-learning classification machine.

At 406, method 400 includes tracking post-health notification user activity of each of the plurality of different users. This may include, for each user, evaluating which activities the user is seen to participate in after notification presentation, as well as examining newly collected health metrics to identify any changes in each user's overall health.

At 408, method 400 includes training a machine-learning classification machine with tracked user activity and corresponding user health metrics for each of the plurality of health notifications. For example, for each particular user, the machine-learning classification machine may track which health notifications have been provided to the user, the user's activity after health-notification presentation, as well as the user's health metrics, and use this information to select health notifications for the user and/or other users in the future.

At 410, method 400 includes providing the machine-learning classification machine with user health metrics received from a health-monitoring computing device associated with a user. As described above, a health-monitoring computing device may be any computing device, such as computing devices 110A and 110B, usable for collecting health metrics of one or more users.

At 412, method 400 includes choosing a selected health notification from the plurality of different health notifications, the selected health notification determined by the machine-learning classification machine to be more likely than all other health notifications of the plurality of different health notifications to elicit a healthy response from the user. This determination may be done, for example, by examining how users with similar health metrics to the user have responded to health notifications in the past, and choosing a health notification that has elicited a healthy response for presentation to the user.

At 414, Method 400 includes sending the selected health notification to the user. As described above with respect to FIG. 2, a physical-health service may send a selected health notification to a user via a computer network, and the selected health notification may be presented to the user by a computing device.

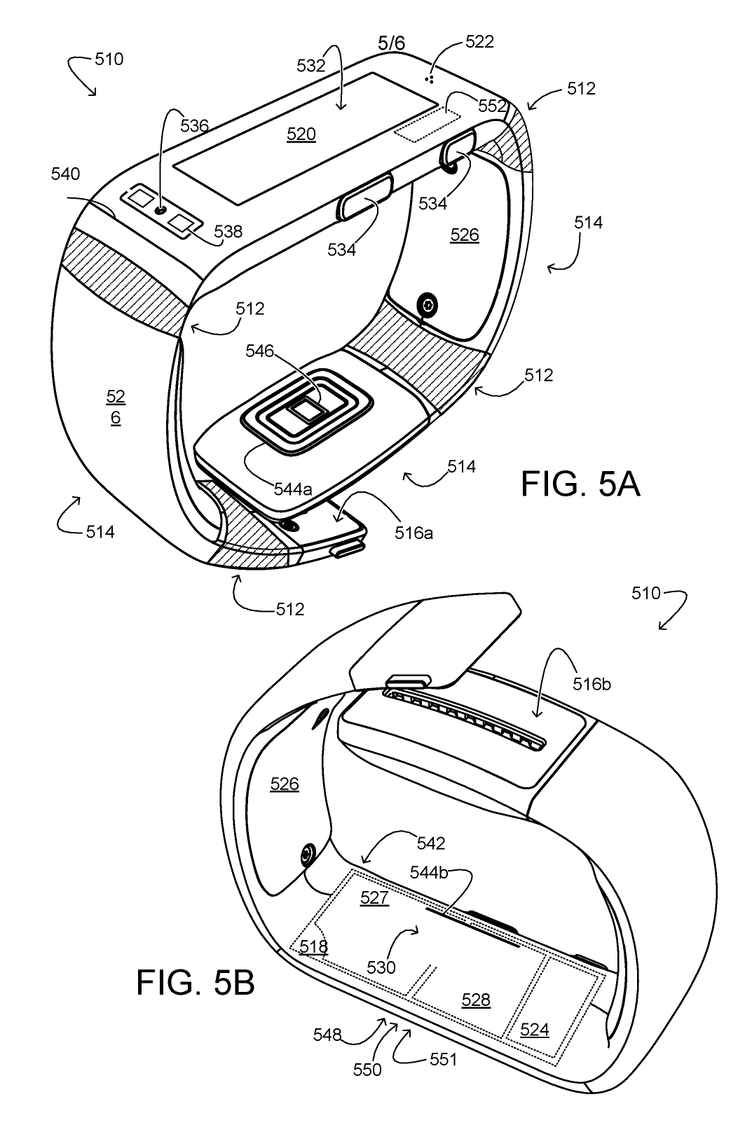

FIGS. 5A and 5B show aspects of an example computing device 510 in the form of a wearable electronic device 510. The illustrated device is band-shaped and may be worn around a wrist. Device 510 includes at least four flexion regions 512 linking less flexible regions 514. The flexion regions of device 510 may be elastomeric in some examples. Fastening componentry 516A and 516B is arranged at both ends of the device. The flexion regions and fastening componentry enable the device to be closed into a loop and to be worn on a user's wrist. In other implementations, wearable electronic devices of a more elongate band shape may be worn around the user's bicep, waist, chest, ankle, leg, head, or other body part. The device, for example, may take the form of eye glasses, a head band, an arm-band, an ankle band, a chest strap, or an implantable device to be implanted in tissue.

Wearable electronic device 510 includes various functional components integrated into regions 514. In particular, the electronic device includes a compute system 518, display 520, loudspeaker 522, communication suite 524, and various sensors. These components draw power from one or more energy-storage cells 526. A battery—e.g., a lithium ion battery—is one type of energy-storage cell suitable for this purpose. Examples of alternative energy-storage cells include super- and ultra-capacitors. In devices worn on the user's wrist, the energy-storage cells may be curved to fit the wrist, as shown in the drawings.

In general, energy-storage cells 526 may be replaceable and/or rechargeable. In some examples, recharge power may be provided through a universal serial bus (USB) port 530, which includes a magnetic latch to releasably secure a complementary USB connector. In other examples, the energy storage cells may be recharged by wireless inductive or ambient-light charging. In still other examples, the wearable electronic device may include electro-mechanical componentry to recharge the energy storage cells from the user's adventitious or purposeful body motion. For example, batteries or capacitors may be charged via an electromechanical generator integrated into device 510. The generator may be turned by a mechanical armature that turns while the user is moving and wearing device 510.

In wearable electronic device 510, compute system 518 is situated below display 520 and operatively coupled to the display, along with loudspeaker 522, communication suite 524, and the various sensors. The compute system includes a data-storage machine 527 to hold data and instructions, and a logic machine 528 to execute the instructions. Aspects of the compute system are described in further detail with reference to FIG. 6.

Display 520 may be any suitable type of display. In some configurations, a thin, low-power light emitting diode (LED) array or a liquid-crystal display (LCD) array may be used. An LCD array may be backlit in some implementations. In other implementations, a reflective LCD array (e.g., a liquid crystal on silicon, LCOS array) may be frontlit via ambient light. A curved display may also be used. Further, AMOLED displays or quantum dot displays may be used.

Communication suite 524 may include any appropriate wired or wireless communications componentry. In FIGS. 5A and 5B, the communications suite includes USB port 530, which may be used for exchanging data between wearable electronic device 510 and other computer systems, as well as providing recharge power. The communication suite may further include two-way Bluetooth, Wi-Fi, cellular, near-field communication and/or other radios. In some implementations, the communication suite may include an additional transceiver for optical, line-of-sight (e.g., infrared) communication.

In wearable electronic device 510, touch-screen sensor 532 is coupled to display 520 and configured to receive touch input from the user. The touch sensor may be resistive, capacitive, or optically based. Pushbutton sensors may be used to detect the state of push buttons 534, which may include rockers. Input from the pushbutton sensors may be used to enact a home-key or on-off feature, control audio volume, turn the microphone on or off, etc.

FIGS. 5A and 5B show various other sensors of wearable electronic device 510. Such sensors include microphone 536, visible-light sensor 538, ultraviolet sensor 540, and ambient temperature sensor 542. The microphone provides input to compute system 518 that may be used to measure the ambient sound level or receive voice commands from the wearer. Input from the visible-light sensor, ultraviolet sensor, and ambient temperature sensor may be used to assess aspects of the wearer's environment—i.e., the temperature, overall lighting level, and whether the wearer is indoors or outdoors.

FIGS. 5A and 5B show a pair of contact sensor modules 544A and 544B, which contact the wearer's skin when wearable electronic device 510 is worn. The contact sensor modules may include independent or cooperating sensor elements, to provide a plurality of sensory functions. For example, the contact sensor modules may provide an electrical resistance and/or capacitance sensory function, which measures the electrical resistance and/or capacitance of the wearer's skin In the illustrated configuration, the separation between the two contact-sensor modules provides a relatively long electrical path length, for more accurate measurement of skin resistance. In some examples, a contact sensor module may also provide measurement of the wearer's skin temperature. Arranged inside contact sensor module 544B in the illustrated configuration is an optical sensor module 546. The optical sensor module may include an optical source configured to illuminate tissue of the user and a matched optical sensor to detect reflected illumination from the tissue of the user. Compute system 518 may use input from the contact sensor modules and/or the optical sensor module to assess whether or not the device is being worn, for instance. In some implementations, the input may be used to determine how tightly the wearable electronic device is being worn. The optical sensor module may be used to determine blood flow through the capillaries in the skin and thereby provide a measurement of the wearer's heart rate, blood oxygen level, blood glucose level, and/or other biomarkers with optical properties.

Wearable electronic device 510 may also include motion sensing componentry, such as an accelerometer 548, gyroscope 550, and magnetometer 551. The accelerometer and gyroscope may furnish inertial and/or rotation rate data along three orthogonal axes as well as rotational data about the three axes, for a combined six degrees of freedom. This sensory data can be used to provide a pedometer / calorie-counting function, for example. Data from the accelerometer and gyroscope may be combined with geomagnetic data from the magnetometer to further define the inertial and rotational data in terms of geographic orientation. The wearable electronic device may also include a global positioning system (GPS) receiver 452 for determining the wearer's geographic location and/or velocity. In some configurations, the antenna of the GPS receiver may be relatively flexible and extend into flexion regions 512.

Compute system 518, via the sensory functions described herein, is configured to acquire various forms of information about the wearer of wearable electronic device 510. Such information must be acquired and used with utmost respect for the wearer's privacy. Accordingly, the sensory functions may be enacted subject to opt-in participation of the wearer. In implementations where personal data is collected on the device and transmitted to a remote system for processing, that data may be anonymized. In other examples, personal data may be confined to the wearable electronic device, and only non-personal, summary data transmitted to the remote system.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 6 schematically shows a non-limiting embodiment of a computing system 600 that can enact one or more of the methods and processes described above. Computing system 600 is shown in simplified form. A computing device 110, as described above, and/or a network-accessible computing device providing a physical-health service may be implemented as a computing system similar to computing system 600. Computing system 600 may take the form of one or more personal computers, server computers, tablet computers, home-entertainment computers, network computing devices, gaming devices, mobile computing devices, mobile communication devices (e.g., smart phone), and/or other computing devices.

Computing system 600 includes a logic machine 602 and a storage machine 606. In some embodiments, logic machine 602 may include a machine-learning classification machine 604, as described above. Computing system 600 may optionally include a display subsystem 608, input subsystem 610, network-communications interface 612, and/or other components not shown in FIG. 6.

Logic machine 602 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 606 includes one or more physical devices configured to hold instructions executable by the logic machine to implement the methods and processes described herein. When such methods and processes are implemented, the state of storage machine 606 may be transformed e.g., to hold different data.

Storage machine 606 may include removable and/or built-in devices. Storage machine 606 may include optical memory (e.g., CD, DVD, HD-DVD, Blu-Ray Disc), semiconductor memory (e.g., RAM, EPROM, EEPROM, etc.), and/or magnetic memory (e.g., hard-disk drive, floppy-disk drive, tape drive, MRAM, etc.), among others. Storage machine 606 may include volatile, nonvolatile, dynamic, static, read/write, read-only, random-access, sequential-access, location-addressable, file-addressable, and/or content-addressable devices.

It will be appreciated that storage machine 606 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 602 and storage machine 606 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 implemented to perform a particular function. In some cases, a module, program, or engine may be instantiated via logic machine 602 executing instructions held by storage machine 606. It will be understood that different modules, programs, and/or engines may be instantiated from the same application, service, code block, object, library, routine, API, function, etc Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 608 may be used to present a visual representation of data held by storage machine 606. This visual representation may take the form of a graphical user interface (GUI). As the herein described methods and processes change the data held by the storage machine, and thus transform the state of the storage machine, the state of display subsystem 608 may likewise be transformed to visually represent changes in the underlying data. Display subsystem 608 may include one or more display devices utilizing virtually any type of technology. Such display devices may be combined with logic machine 602 and/or storage machine 606 in a shared enclosure, or such display devices may be peripheral display devices.

When included, input subsystem 610 may comprise or interface with one or more user-input devices such as a keyboard, mouse, touch screen, game controller, and/or other input modalities. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, network-communications interface 612 may be configured to communicatively couple computing system 600 with one or more other computing devices. Network-communications interface 612 may include wired and/or wireless communication devices compatible with one or more different communication protocols. As non-limiting examples, the network-communications interface may be configured for communication via a wireless telephone network, or a wired or wireless local- or wide-area network. In some embodiments, the network-communications interface may allow computing system 600 to send and/or receive messages to and/or from other devices via a network such as the Internet.

In an example, a method for presenting health notifications comprises: creating a plurality of different health notifications to convey a same type of health information; providing each of the plurality of different health notifications to a plurality of different users, each different user categorized with user health metrics; tracking post-health notification user activity of each of the plurality of different users; training a machine-learning classification machine with tracked user activity and corresponding user health metrics for each of the plurality of health notifications; providing the machine-learning classification machine with user health metrics received from a health-monitoring computing device associated with a user; choosing a selected health notification from the plurality of different health notifications, the selected health notification determined by the machine-learning classification machine to be more likely than all other health notifications of the plurality of different health notifications to elicit a healthy response from the user; and sending the selected health notification to the user. In this example or any other example, user health metrics for each of the plurality of different users are converted into vectors, and the machine-learning classification machine is configured to choose the selected health notification using a vector as an input. In this example or any other example, each vector includes a plurality of dimensions, and each dimension corresponds to a different user health metric. In this example or any other example, each vector has a vector component in each dimension, and a magnitude of the vector component in each dimension is proportional to a value of a health metric corresponding to the dimension. In this example or any other example, the machine-learning classification machine is subsequently re-trained as new tracked post-health notification user activity is received. In this example or any other example, providing each of the plurality of different health notifications to the plurality of different users comprises randomly selecting health notifications from the plurality of different health notifications and sending selected notifications to a plurality of computing devices associated with the plurality of different users. In this example or any other example, user health metrics include a current location of the user, and local weather conditions at the current location. In this example or any other example, the user health metrics include user health metrics measured by one or more health sensors of a plurality of computing devices associated with the plurality of different users.

In an example, a network-accessible computer comprises: a network-communications interface configured to provide a plurality of different health notifications to a plurality of computing devices associated with different users, where each of the plurality of different health notifications convey a same type of information, and each of the different users is categorized with user health metrics; the network-communications interface configured to receive tracked post-notification user activity for each of the plurality of different individuals from the plurality of computing devices; a machine-learning classification machine configured to automatically choose a selected health notification of the plurality of different health notifications for a user based on user health metrics for the user, where the selected health notification is determined by the machine-learning classification machine to be more likely than all other health notifications of the plurality of different health notifications to elicit a healthy response from the user, the machine-learning classification machine previously trained with tracked post-notification user activity and corresponding user health metrics for each of the plurality of different health notifications; and the network-communications interface configured to send the selected health notification to the user. In this example or any other example, the user health metrics include user health metrics measured by one or more health sensors of the plurality of computing devices. In this example or any other example, the user health metrics include health metrics manually input via one or more input modalities of one or more computing devices. In this example or any other example, user health metrics for each of the plurality of different individuals are converted into vectors, and the machine-learning classification machine is configured to choose the selected health notification using a vector as an input. In this example or any other example, each vector includes a plurality of dimensions, and each dimension corresponds to a different user health metric. In this example or any other example, each vector has a vector component in each dimension, and a magnitude of the vector component in each dimension is proportional to a value of a health metric corresponding to the dimension. In this example or any other example, the machine-learning classification machine is subsequently re-trained as new tracked post-notification user activity is received. In this example or any other example, the machine-learning classification machine performs one or more random selection operations when providing each of the plurality of different health notifications to each of the plurality of computing devices. In this example or any other example, the network-communications interface is configured to send the selected health notification to the user at a time determined by the machine-learning classification machine. In this example or any other example, user health metrics include a current location of the user, and local weather conditions at the current location.

In an example, a method for presenting health notifications comprises: creating a plurality of different health notifications; providing health notifications of the plurality to a plurality of different users, where each provided health notification conveys a same type of health notification, and each different user is categorized with user health metrics; tracking post-health notification user activity of each of the plurality of different users; training a machine-learning classification machine with tracked user activity and corresponding user health metrics for each of the plurality of health notifications; recognizing a type of information to be conveyed to a user; providing the machine-learning classification machine with user health metrics received from a health-monitoring computing device associated with the user; choosing a selected health notification from a set of health notifications conveying the recognized type of information, the selected health notification determined by the machine-learning classification machine to be more likely than all other health notifications of the set to elicit a healthy response from the user; and sending the selected health notification to the user. In this example or any other example, the machine-learning classification machine is subsequently re-trained as new tracked post-health notification user activity is received.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

Claims:

1. A method for presenting health notifications, comprising:
creating a plurality of different health notifications to convey a same type of health information;
providing each of the plurality of different health notifications to a plurality of different users, each different user categorized with user health metrics;
tracking post-health notification user activity of each of the plurality of different users;
training a machine-learning classification machine with tracked user activity and corresponding user health metrics for each of the plurality of health notifications;
providing the machine-learning classification machine with user health metrics received from a health-monitoring computing device associated with a user;
choosing a selected health notification from the plurality of different health notifications, the selected health notification determined by the machine-learning classification machine to be more likely than all other health notifications of the plurality of different health notifications to elicit a healthy response from the user; and
sending the selected health notification to the user.

2. The method of claim 1, where user health metrics for each of the plurality of different users are converted into vectors, and the machine-learning classification machine is configured to choose the selected health notification using a vector as an input.

3. The method of claim 2, where each vector includes a plurality of dimensions, and each dimension corresponds to a different user health metric.

4. The method of claim 3, where each vector has a vector component in each dimension, and a magnitude of the vector component in each dimension is proportional to a value of a health metric corresponding to the dimension.

5. The method of claim 1, wherein the machine-learning classification machine is subsequently re-trained as new tracked post-health notification user activity is received.

6. The method of claim 1, wherein providing each of the plurality of different health notifications to the plurality of different users comprises randomly selecting health notifications from the plurality of different health notifications and sending selected notifications to a plurality of computing devices associated with the plurality of different users.

7. The method of claim 1, wherein user health metrics include a current location of the user, and local weather conditions at the current location.

8. The method of claim 1, wherein the user health metrics include user health metrics measured by one or more health sensors of a plurality of computing devices associated with the plurality of different users.

9. A network-accessible computer, comprising:
a network-communications interface configured to provide a plurality of different health notifications to a plurality of computing devices associated with different users, where each of the plurality of different health notifications convey a same type of information, and each of the different users is categorized with user health metrics;
the network-communications interface configured to receive tracked post-notification user activity for each of the plurality of different individuals from the plurality of computing devices;
a machine-learning classification machine configured to automatically choose a selected health notification of the plurality of different health notifications for a user based on user health metrics for the user, where the selected health notification is determined by the machine-learning classification machine to be more likely than all other health notifications of the plurality of different health notifications to elicit a healthy response from the user, the machine-learning classification machine previously trained with tracked post-notification user activity and corresponding user health metrics for each of the plurality of different health notifications; and
the network-communications interface configured to send the selected health notification to the user.

10. The network-accessible computer of claim 9, wherein the user health metrics include user health metrics measured by one or more health sensors of the plurality of computing devices.

11. The network-accessible computer of claim 9, wherein the user health metrics include health metrics manually input via one or more input modalities of one or more computing devices.

12. The network-accessible computer of claim 9, where user health metrics for each of the plurality of different individuals are converted into vectors, and the machine-learning classification machine is configured to choose the selected health notification using a vector as an input.

13. The network-accessible computer of claim 12, where each vector includes a plurality of dimensions, and each dimension corresponds to a different user health metric.

14. The network-accessible computer of claim 13, where each vector has a vector component in each dimension, and a magnitude of the vector component in each dimension is proportional to a value of a health metric corresponding to the dimension.

15. The network-accessible computer of claim 9, wherein the machine-learning classification machine is subsequently re-trained as new tracked post-notification user activity is received.

16. The network-accessible computer of claim 9, wherein the machine-learning classification machine performs one or more random selection operations when providing each of the plurality of different health notifications to each of the plurality of computing devices.

17. The network-accessible computer of claim 9, wherein the network-communications interface is configured to send the selected health notification to the user at a time determined by the machine-learning classification machine.

18. The network-accessible computer of claim 9, wherein user health metrics include a current location of the user, and local weather conditions at the current location.

19. A method for presenting health notifications, comprising:
creating a plurality of different health notifications;
providing health notifications of the plurality to a plurality of different users, where each provided health notification conveys a same type of health notification, and each different user is categorized with user health metrics;
tracking post-health notification user activity of each of the plurality of different users;
training a machine-learning classification machine with tracked user activity and corresponding user health metrics for each of the plurality of health notifications;
recognizing a type of information to be conveyed to a user;
providing the machine-learning classification machine with user health metrics received from a health-monitoring computing device associated with the user;
choosing a selected health notification from a set of health notifications conveying the recognized type of information, the selected health notification determined by the machine-learning classification machine to be more likely than all other health notifications of the set to elicit a healthy response from the user; and
sending the selected health notification to the user.

20. The method of claim 19, wherein the machine-learning classification machine is subsequently re-trained as new tracked post-health notification user activity is received.
